(19) United States
(12) Patent Application Publication
(10) Pub. No.: US 2014/0208728 A1
(43) Pub. Date: Jul. 31, 2014

(54) Method and Hydraulic Control System Having Swing Motor Energy Recovery

(71) Applicant: CATERPILLAR INC., Peoria, IL (US)

(72) Inventors: Pengfei Ma, Naperville, IL (US); Victor Wen, Dunlap, IL (US); Jiao Zhang, Naperville, IL (US); Dayao Chen, Bolingbrook, IL (US); Tonglin Shang, Bolingbrook, IL (US); Aleksandar M. Egelja, Naperville, IL (US)

(73) Assignee: CATERPILLAR INC., Peoria, IL (US)

(21) Appl. No.: 13/752,085

(22) Filed: Jan. 28, 2013

(51) Int. Cl. E02F 9/22; F15B 11/042; F15B 13/04

(52) U.S. Cl. CPC E02F 9/2217; F15B 13/04; F15B 11/042
USPC 60/327; 60/414; 60/464; 91/363 R

(57) ABSTRACT

A hydraulic control system includes a swing control valve between a pump and a swing motor to control flow to/from the swing motor, and a selector valve between an accumulator and the swing motor to regulate fluid flow. A controller is configured to receive inputs indicative of the pressure differential between the accumulator and conduit between the pump and swing motor, and a swing motor command, calculate a target swing motor flow based on the swing motor command input, and modulate operation of the swing control valve and the selector valve to regulate a swing speed.

### TECHNICAL FIELD

The present disclosure relates generally to a hydraulic control system and, more particularly, to a hydraulic control system having swing energy recovery.

### BACKGROUND

Swing-type excavation machines, for example hydraulic excavators and front shovels, require significant hydraulic pressure and flow to transfer material from a dig location to a dump location. These machines direct the high-pressure fluid from an engine-driven pump through a swing motor to accelerate a loaded work tool at the start of each swing, and then restrict the flow of fluid exiting the motor at the end of each swing to slow and stop the work tool.

One problem associated with this type of hydraulic arrangement involves efficiency. In particular, the fluid exiting the swing motor at the end of each swing is under a relatively high pressure due to deceleration of the loaded work tool. Unless recovered, energy associated with the high-pressure fluid may be wasted. In addition, restriction of this high-pressure fluid exiting the swing motor at the end of each swing can result in heating of the fluid, which must be accommodated with an increased cooling capacity of the machine.

One attempt to improve the efficiency of a swing-type machine is disclosed in U.S. Publication No. 2013/0000289 of Zhang et al. published Jan. 3, 2013. The publication discloses a hydraulic control system for a machine that includes an accumulator. The accumulator stores exit oil from a swing motor that has been pressurized by inertia torque applied on the moving swing motor by an upper structure of the machine. The pressurized oil in the accumulator is then selectively reused to accelerate the swing motor during a subsequent swing by supplying the accumulated oil back to the swing motor.

### SUMMARY

The disclosure describes, in one aspect, a hydraulic control system including a tank, a pump configured to draw fluid from the tank and pressurize the fluid, and a swing motor driven by a flow of pressurized fluid. The swing motor has a first chamber and a second chamber, the swing motor is adapted to move in a first direction when fluid flows into the swing motor through the first chamber, the swing motor adapted to move in a second direction when fluid flows into the swing motor through the second chamber. At least one swing control valve is configured to control fluid flow between the pump, the swing motor, and the tank. An accumulator is configured to selectively receive pressurized fluid discharged from the swing motor and selectively supply pressurized fluid to the swing motor. At least one electrically-operated selector valve is configured to regulate fluid flow into and out of the accumulator. At least one pressure sensor is disposed to detect a pressure differential between the accumulator and at least one of the first chamber and the second chamber. A controller is provided in communication with the control valve and the selector valve. The controller is configured to receive input indicative of the pressure differential between the accumulator and at least one of the first chamber and the second chamber, receive a swing motor command input, calculate a target swing motor flow based on the swing motor command input, and modulate operation of the swing control valve and the selector valve to regulate a swing speed.

The disclosure describes, in another aspect, a method of controlling a swing motor of a machine. The method includes receiving input indicative of a pressure differential between an accumulator and at least one of a first chamber conduit and a second chamber conduit in communication with first and second chambers of a swing motor, respectively, receiving a swing motor command input, calculating a target swing motor flow based on the swing motor command input, and modulating operation of a swing control valve in communication with a pump and at least one selector valve in communication with the accumulator to regulate a swing speed of the swing motor.

### BRIEF DESCRIPTION OF THE DRAWINGS

FIG. 1 is a diagrammatic illustration of an exemplary disclosed machine operating at a worksite with a haul vehicle;

FIG. 2 is a schematic illustration of an exemplary disclosed hydraulic control system that may be used with the machine of FIG. 1;

FIG. 3 is an exemplary disclosed control map that may be used by the hydraulic control system of FIG. 2;

FIG. 4 is a flowchart depicting an exemplary disclosed method that may be performed by the hydraulic control system of FIG. 2; and

FIG. 5 is a flowchart depicting an alternate embodiment of an exemplary disclosed method that may be performed by the hydraulic control system of FIG. 2.

### DETAILED DESCRIPTION

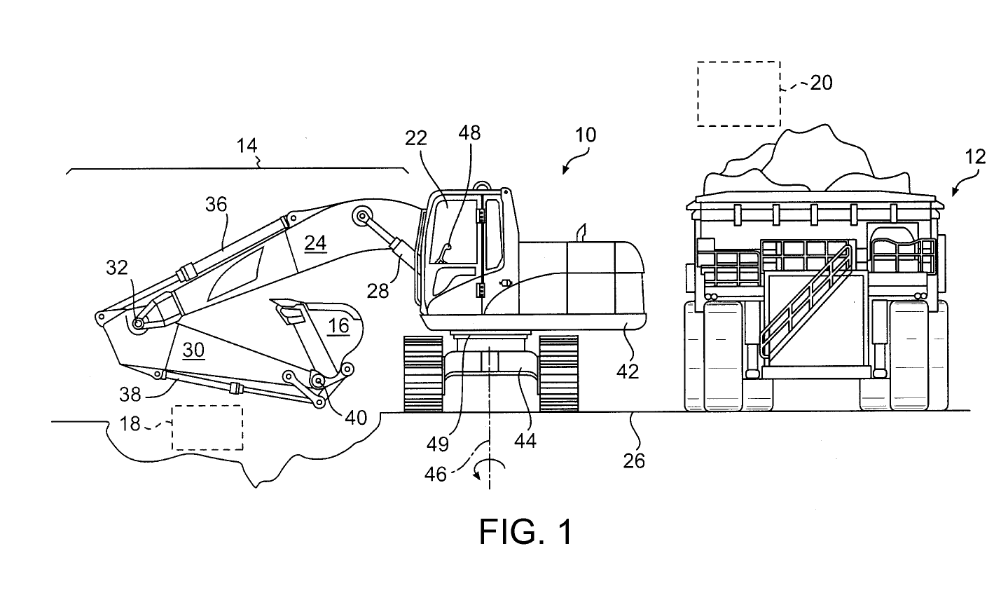

FIG. 1 illustrates an exemplary machine 10 having multiple systems and components that cooperate to excavate and load earthen material onto a nearby haul vehicle 12. In the depicted example, machine 10 is a hydraulic excavator. It is contemplated, however, that machine 10 could alternatively embody another swing-type excavation or material handling machine, such as a backhoe, a front shovel, a dragline excavator, or another similar machine. Machine 10 may include, among other things, an implement system 14 configured to move a work tool 16 between a dig location 18 within a trench or at a pile, and a dump location 20, for example over haul vehicle 12. Machine 10 may also include an operator station 22 for manual control of implement system 14. It is contemplated that machine 10 may perform operations other than truck loading, if desired, such as craning, trenching, and material handling.

Implement system 14 may include a linkage structure acted on by fluid actuators to move work tool 16. Specifically, implement system 14 may include a boom 24 that is vertically pivotal relative to a work surface 26 by a pair of adjacent, double-acting, hydraulic cylinders 28 (only one shown in FIG. 1). Implement system 14 may also include a stick 30 that is vertically pivotal about a horizontal pivot axis 32 relative to boom 24 by a single, double-acting, hydraulic cylinder 36. Implement system 14 may further include a single, double-acting, hydraulic cylinder 38 that is operatively connected to work tool 16 to tilt work tool 16 vertically about a horizontal pivot axis 40 relative to stick 30. Boom 24 may be pivotally connected to a frame 42 of machine 10, while frame 42 may be pivotally connected to an undercarriage member 44 and swung about a vertical axis 46 by a swing motor 49. Stick 30 may pivotally connect work tool 16 to boom 24 by way of pivot axes 32 and 40. It is contemplated that a greater or lesser number of fluid actuators may be included within implement system 14 and connected in a manner other than described above, if desired.

Numerous different work tools 16 may be attachable to a single machine 10 and controllable via operator station 22. Work tool 16 may include any device used to perform a particular task such as, for example, a bucket, a fork arrangement, a blade, a shovel, a crusher, a shear, a grapple, a grapple bucket, a magnet, or any other task-performing device known in the art. Although connected in the embodiment of FIG. 1 to lift, swing, and tilt relative to machine 10, work tool 16 may alternatively or additionally rotate, slide, extend, open and close, or move in another manner known in the art.

Operator station 22 may be configured to receive input from a machine operator indicative of a desired work tool movement. Specifically, operator station 22 may include one or more input devices 48 embodied, for example, as single or multi-axis joysticks located proximal an operator seat (not shown). Input devices 48 may be proportional-type controllers configured to position and/or orient work tool 16 by producing a work tool position signal that is indicative of a desired work tool speed and/or force in a particular direction. The position signal may be used to actuate any one or more of hydraulic cylinders 28, 36, 38 and/or swing motor 49. It is contemplated that different input devices may alternatively or additionally be included within operator station 22 such as, for example, wheels, knobs, push-pull devices, switches, pedals, and other operator input devices known in the art. For the purposes of this disclosure, the term “input device” is intended to include all such devices.

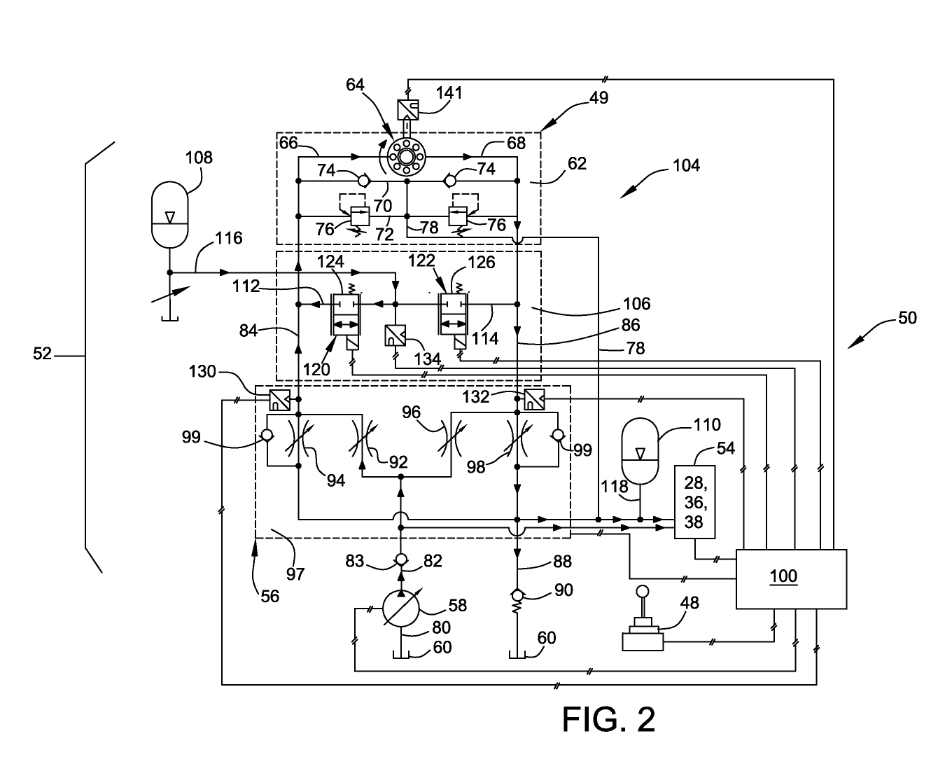

As illustrated in FIG. 2, machine 10 may include a hydraulic control system 50 having a plurality of fluid components that cooperate to move implement system 14 (referring to FIG. 1). In particular, hydraulic control system 50 may include a first circuit 52 associated with swing motor 49, and at least a second circuit 54 associated with hydraulic cylinders 28, 36, and 38. First circuit 52 may include, among other things, a swing control valve 56 connected to regulate a flow of pressurized fluid from a pump 58 to swing motor 49 and from swing motor 49 to a low-pressure tank 60 to cause a swinging movement of work tool 16 about axis 46 (referring to FIG. 1) in accordance with an operator request received via input device 48. Second circuit 54 may include similar control valves, for example a boom control valve (not shown), a stick control valve (not shown), a tool control valve (not shown), a travel control valve (not shown), and/or an auxiliary control valve connected in parallel to receive pressurized fluid from pump 58 and to discharge waste fluid to tank 60, thereby regulating the corresponding actuators (e.g., hydraulic cylinders 28, 36, and 38).

Swing motor 49 may include a housing 62 at least partially forming a first and a second chamber (not shown) located to either side of an impeller 64. When the first chamber is connected to an output of pump 58 (e.g., via a first chamber passage 66 formed within housing 62) and the second chamber is connected to tank 60 (e.g., via a second chamber passage 68 formed within housing 62), impeller 64 may be driven to rotate in a first direction (shown in FIG. 2). Conversely, when the first chamber is connected to tank 60 via first chamber passage 66 and the second chamber is connected to pump 58 via second chamber passage 68, impeller 64 may be driven to rotate in an opposite direction (not shown). The flow rate of fluid through impeller 64 may relate to a rotational speed of swing motor 49, while a pressure differential across impeller 64 may relate to an output torque thereof.

Swing motor 49 may include built-in makeup and relief functionality. In particular, a makeup passage 70 and a relief passage 72 may be formed within housing 62, between first chamber passage 66 and second chamber passage 68. A pair of opposing check valves 74 and a pair of opposing relief valves 76 may be disposed within makeup and relief passages 70, 72, respectively. A low-pressure passage 78 may be connected to each of makeup and relief passages 70, 72 at locations between check valves 74 and between relief valves 76. Based on a pressure differential between low-pressure passage 78 and first and second chamber passages 66, 68, one of check valves 74 may open to allow fluid from low-pressure passage 78 into the lower-pressure one of the first and second chambers. Similarly, based on a pressure differential between first and second chamber passages 66, 68 and low-pressure passage 78, one of relief valves 76 may open to allow fluid from the higher-pressure one of the first and second chambers into low-pressure passage 78. A significant pressure differential may generally exist between the first and second chambers during a swinging movement of implement system 14.

Pump 58 may be configured to draw fluid from tank 60 via an inlet passage 80, pressurize the fluid to a desired level, and discharge the fluid to first and second circuits 52, 54 via a pump discharge passage 82. A check valve 83 may be disposed within pump discharge passage 82, if desired, to provide for a unidirectional flow of pressurized fluid from pump 58 into first and second circuits 52, 54. Pump 58 may embody, for example, a variable displacement pump (shown in FIG. 2), a fixed displacement pump, or another source known in the art. Pump 58 may be drivably connected to a power source (not shown) of machine 10 by, for example, a countershaft (not shown), a belt (not shown), an electrical circuit (not shown), or in another suitable manner. Alternatively, pump 58 may be indirectly connected to the power source of machine 10 via a torque converter, a reduction gear box, an electrical circuit, or in any other suitable manner. Pump 58 may produce a stream of pressurized fluid having a pressure level and/or a flow rate determined, at least in part, by demands of the actuators within first and second circuits 52, 54 that correspond with operator requested movements. Pump discharge passage 82 may be connected within first circuit 52 to first and second chamber passages 66, 68 via swing control valve 56 and first and second chamber conduits 84, 86, respectively, which extend between swing control valve 56 and swing motor 49.

Tank 60 may constitute a reservoir configured to hold a low-pressure supply of fluid. The fluid may include, for example, dedicated hydraulic oil, engine lubrication oil, transmission lubrication oil, or any other fluid known in the art. One or more hydraulic systems within machine 10 may draw fluid from and return fluid to tank 60. It is contemplated that hydraulic control system 50 may be connected to multiple separate fluid tanks or to a single tank, as desired. Tank 60 may be fluidly connected to swing control valve 56 via a drain passage 88, and to first and second chamber passages 66, 68 via swing control valve 56 and first and second chamber conduits 84, 86, respectively. Tank 60 may also be connected to low-pressure passage 78. A check valve 90 may be disposed within drain passage 88, if desired, to promote a unidirectional flow of fluid into tank 60.

Swing control valve 56 may have elements that are movable to control the rotation of swing motor 49 and corresponding swinging motion of implement system 14. Specifically, swing control valve 56 may include a first chamber supply element 92, a first chamber drain element 94, a second chamber supply element 96, and a second chamber drain element 98, which all may be disposed within a common block or housing 97. The first and second chamber supply elements 92, 96 may be connected in parallel with one another and to pump discharge passage 82 to regulate filling of their respective chambers with fluid from pump 58, while the first and second chamber drain elements 94, 98 may be connected in parallel with one another and to drain passage 88 to regulate draining of the respective chambers of fluid. A makeup valve 99, for example a check valve, may be disposed between an outlet of first chamber drain element 94 and first chamber conduit 84 and between an outlet of second chamber drain element 98 and second chamber conduit 86.

To drive swing motor 49 to rotate in a first direction (shown in FIG. 2), first chamber supply element 92 may be shifted to allow pressurized fluid from pump 58 to enter the first chamber of swing motor 49 via pump discharge passage 82 and first chamber conduit 84, while second chamber drain element 98 may be shifted to allow fluid from the second chamber of swing motor 49 to drain to tank 60 via second chamber conduit 86 and drain passage 88. To drive swing motor 49 to rotate in the opposite direction, second chamber supply element 96 may be shifted to communicate the second chamber of swing motor 49 with pressurized fluid from pump 58, while first chamber drain element 94 may be shifted to allow draining of fluid from the first chamber of swing motor 49 to tank 60. It is contemplated that both the supply and drain functions of swing control valve 56 (i.e., of the four different supply and drain elements) may alternatively be performed by a single valve element associated with the first chamber and a single valve element associated with the second chamber, or by a single valve element associated with both the first and second chambers, if desired.

Supply and drain elements 92, 94, 96, 98 of swing control valve 56 may be solenoid-movable against a spring bias in response to a flow rate and/or position command issued by a controller 100. In particular, swing motor 49 may rotate at a velocity that corresponds with the flow rate of fluid into and out of the first and second chambers. Accordingly, to achieve an operator-desired swing torque, a command based on an assumed or measured pressure drip may be sent to the solenoids (not shown) of supply and drain elements 92, 94, 96, 98 that causes them to open an amount corresponding to the necessary fluid pressure at swing motor 49. This command may be in the form of a flow rate command or a valve element position command that is issued by a controller 100.

Controller 100 may be in communication with the different components of hydraulic control system 50 to regulate operations of machine 10. For example, controller 100 may be in communication with the elements of swing control valve 56 in first circuit 52 and with the elements of control valves (not shown in detail) associated with second circuit 54. Based on various operator input and monitored parameters, as will be described in more detail below, controller 100 may be configured to selectively activate the different control valves in a coordinated manner to efficiently carry out operator requested movements of implement system 14.

Controller 100 may include a memory, a secondary storage device, a clock, and one or more processors that cooperate to accomplish a task consistent with the present disclosure. Numerous commercially available microprocessors can be configured to perform the functions of controller 100. It should be appreciated that controller 100 could readily embody a general machine controller capable of controlling numerous other functions of machine 10. Various known circuits may be associated with controller 100, including signal-conditioning circuitry, communication circuitry, and other appropriate circuitry. It should also be appreciated that controller 100 may include one or more of an application-specific integrated circuit (ASIC), a field-programmable gate array (FPGA), a computer system, and a logic circuit configured to allow controller 100 to function in accordance with the present disclosure.

Hydraulic control system 50 may be fitted with an energy recovery arrangement (ERA) 104 that is in communication with at least first circuit 52 and configured to selectively extract and recover energy from waste fluid that is discharged from swing motor 49. Energy recovery arrangement 104 may include, among other things, a recovery valve block (RVB) 106 that is fluidly connectable between pump 58 and swing motor 49, a first accumulator 108 configured to selectively communicate with swing motor 49 via RVB 106, and a second accumulator 110 also configured to selectively and directly communicate with swing motor 49. In the disclosed embodiment, RVB 106 may be fixedly and mechanically connectable to one or both of swing control valve 56 and swing motor 49, for example directly to housing 62 of the swing motor 49 and/or directly to housing 97 of the swing control valve 56. RVB 106 may include an internal first passage 112 fluidly connectable to first chamber conduit 84, and an internal second passage 114 fluidly connectable to second chamber conduit 86. First accumulator 108 may be fluidly connected to RVB 106 via a conduit 116, while second accumulator 110 may be fluidly connectable to low-pressure and drain passages 78 and 88, in parallel with tank 60, via a conduit 118.

RVB 106 includes at least one selector valve 120, 122 associated with first accumulator 108. While the at least one selector valve may include a three port, three way valve, for example, the illustrated embodiment includes a pair of selector valves 120, 122, each of which is a two port, two way, variable position valve. A valve element 124, 126 of each selector valve 120, 122 is moveable from a closed position that prevents the flow of fluid between the ports toward an open position that permit flow between the ports. Inasmuch as the illustrated selector valves 120, 122 are variable position, as the respective valve element 124, 126 moves from the normally closed position, i.e., a position wherein flow of fluid is blocked, flow may be established through an internal opening (not specifically illustrated, but understood by those of skill in the art), the flow being dependent, at least in part, by the size of the opening as the valve element 124, 126 moves from the closed position. For the purposes of this disclosure, with regard to valve operation and structure, the terms “closed” and “closed position” will refer to a position in which flow of fluid through the valve is blocked, and the terms “open” and “open position” will refer to any position in which fluid flow through the valve is not blocked.

More specifically, when valve element 124 of the first selector valve 120 is disposed in the closed position, the first selector valve 120 does not allow fluid flow between conduit 116 and internal first passage 112; that is, it does not allow fluid flow between the first accumulator 108 and first chamber conduit 84. Conversely, when valve element 124 of the first selector valve 120 is away from the closed position (i.e., in the open position or in an intermediate position between the closed and fully open positions), the first selector valve 120 allows fluid flow between conduit 116 and internal first passage 112; that is, it allows fluid flow between the first accumulator 108 and first chamber conduit 84.

Similarly, when valve element 126 of the second selector valve 122 is disposed in the closed position, the second selector valve 122 does not allow fluid flow between conduit 116 and internal second passage 114; that is, it does not allow fluid flow between the first accumulator 108 and first chamber conduit 84. Conversely, when valve element 126 of the second selector valve 122 is away from the closed position (i.e., in the open position or in an intermediate position between the closed and fully open positions), the second selector valve 122 allows fluid flow between conduit 116 and internal second passage 114; that is, it allows fluid flow between the first accumulator 108 and first chamber conduit 84.

The resultant fluid flow when either of the selector valves 120, 122 is in other than the blocked or closed position will be dependent upon the extent to which the respective selector valve 120, 122 is opened, as well as the pressure differential between the fluid as contained on either side of the respective selector valve 120, 122. In other words, when the first selector valve 120 is in other than the closed position, flow across the first selector valve 120 will be dependent upon not only the extent to which the first selector valve 120 is opened, but also the difference in the pressure of the fluid in the conduit 116, that is, the first accumulator 108, and the fluid contained in the internal first passage 112, that is, in the first chamber conduit 84.

When a fluid pressure within the first chamber conduit 84 exceeds a fluid pressure within first accumulator 108 and valve element 124 is away from the closed position (i.e., in the open position or in an intermediate position between the closed and fully open positions), fluid from the first chamber conduit 84 may fill (i.e., charge) first accumulator 108. Conversely, when a fluid pressure within the first accumulator 108 exceeds the fluid pressure in the first chamber conduit 84 and valve element 124 is away from the closed position (i.e., in the open position or in an intermediate position between the closed and fully open positions), fluid from the first accumulator 108 may flow to the first chamber conduit 84. In this way, flow from the first accumulator 108 may power the swing motor 49 in a first direction, either alone, or supplementing flow from the pump 58.

Likewise, when a fluid pressure within the second chamber conduit 86 exceeds a fluid pressure within first accumulator 108 and valve element 126 is away from the closed position (i.e., in the open position or in an intermediate position between the closed and fully open positions), fluid from the second chamber conduit 86 may fill (i.e., charge) first accumulator 108. Conversely, when a fluid pressure within the first accumulator 108 exceeds the fluid pressure in the second chamber conduit 86 and valve element 126 is away from the closed position (i.e., in the open position or in an intermediate position between the closed and fully open positions), fluid from the first accumulator 108 may flow to the second chamber conduit 86. In this way, flow from the first accumulator 108 may power the swing motor 49 in a second direction, either alone, or supplementing flow from the pump 58.

Flow toward the swing motor 49 may be established based upon flow from the first for second accumulator 108, 110 and/or flow from the pump 58. The extent to which the flow from the first accumulator 108 or flow from the pump 58 powers the swing motor 49 in either direction will be dependent upon both the fluid pressures in the first accumulator 108 and the first chamber conduit 84, as well as the extent to which the first or second selector valve 120, 122 and the swing control valve 56, and, more specifically, the first or second chamber supply element 92, 96, are opened to permit flow therethrough. When flow occurs from either the first or second chamber conduit 84, 86 and the internal first or second passage 112, 114 to the conduit 116 and first accumulator 108, flow may be established based upon the recovery of fluid flowing from the swing motor 49 as a result of deceleration or from the pump 58 as a result of excess pump capacity. Accordingly, flow toward the first accumulator 108 is likewise dependent upon the pressures in the first or second chamber conduit 84, 86 and the first accumulator 108, as well as the extent to which the first or second selector valve 120, 122 is opened to permit flow toward the first accumulator 108, and the extent to which the swing control valve 56, more specifically, the first or second chamber drain element 94, 98, are opened to permit flow therethrough.

According to an aspect of the arrangement, the selector valves 120, 122 are electrically operated such that they may be controlled by the controller 100. As may be seen in FIG. 2, the selector valves 120, 122 include valve elements 124, 126 that are spring biased into their first, closed position, and movable in response to a command from controller 100 to any position between the closed and fully open positions to thereby vary a flow rate of fluid between either of the first or second passages 112, 114 and the first accumulator 108, depending upon the respective pressures. The illustrated selector valves 120, 122 are solenoid operated with regard to movement from the first, closed position. Alternate arrangements are envisioned, however. In an alternate embodiment, for example, the selector valves 120, 122 may be solenoid operated in either direction. Further, while two selector valves 120, 122 are illustrated and discussed in detail with regard to the operation of the first circuit 52, alternate embodiments may be utilized, and may include, by way of example only, a single three port valve (not shown) that may be solenoid operated for movement between the three positions in lieu of the two selector valves 120, 122.

Various operational parameters within first and/or second circuits 52, 54 may be monitored by the controller 100. For example, one or more pressure sensors 130, 132 may be strategically located within first chamber and/or second chamber conduits 84, 86 to sense a pressure of the respective passages and generate a corresponding signal indicative of the pressure directed to controller 100.

An additional pressure sensor 134 may be associated with first accumulator 108 and configured to generate signals indicative of a pressure of fluid within first accumulator 108. In the disclosed embodiment, the additional pressure sensor 134 may be disposed between first accumulator 108 and one or both of the selector valves 120, 122. It is contemplated, however, that the additional pressure sensor 134 may be alternatively disposed, such as, for example, directly connected to first accumulator 108, if desired. Signals from the pressure sensors 130, 132, 134 may be directed to controller 100 for use in regulating operation of selector valves 120, 122 and the swing control valve 56.

It is contemplated that any number of pressure sensors may be placed in any location within first and/or second circuits 52, 54, as desired. It is further contemplated that other operational parameters such as, for example, speeds, temperatures, viscosities, densities, etc. may also or alternatively be monitored and used to regulate operation of hydraulic control system 50, if desired. For example, one or more performance sensors 141 may monitor the rotational speed and direction of the swing motor 49.

First and second accumulators 108, 110 may each embody pressure vessels filled with a compressible gas that are configured to store pressurized fluid for future use by swing motor 49. The compressible gas may include, for example, nitrogen, argon, helium, or another appropriate compressible gas. As fluid in communication with first and second accumulators 108, 110 exceeds predetermined pressures of first and second accumulators 108, 110, the hydraulic control system 50 may be configured to allow the fluid to flow into one or both of accumulators 108, 110. Because the gas therein is compressible, it may act like a spring and compress as the fluid flows into first and second accumulators 108, 110. When the pressure of the fluid within conduits 116, 118 drops below the predetermined pressures of first and second accumulators 108, 110, the compressed gas may expand and urge the fluid from within first and second accumulators 108, 110 to exit. It is contemplated that first and second accumulators 108, 110 may alternatively embody membrane/spring-biased or bladder types of accumulators, if desired.

In the disclosed embodiment, first accumulator 108 may be a larger (i.e., about 5-20 times larger) and higher-pressure (i.e., about 5-60 times higher-pressure) accumulator, as compared to second accumulator 110. Specifically, first accumulator 108 may be configured to accumulate up to about 50-100L of fluid having a pressure in the range of about 260-300 bar, while second accumulator 110 may be configured to accumulate up to about 10L of fluid having a pressure in the range of about 5-30 bar. In this configuration, first accumulator 108 may be used primarily to assist the motion of swing motor 49 and to improve machine efficiencies, while second accumulator may be used primarily as a makeup accumulator to help reduce a likelihood of voiding at swing motor 49. It is contemplated, however, that other volumes and pressures may be accommodated by first and/or second accumulators 108, 110, if desired.

Controller 100 is configured to modulate the operation of the swing control valve 56 and the first and second selector valves 120, 122 to provide a commanded rotational speed and direction of the swing motor. In this way, the controller 100 selectively causes the first accumulator 108 to charge and discharge, thereby improving performance of machine 10. In particular, a typical swinging motion of implement system 14 instituted by swing motor 49 may consist of segments of time during which swing motor 49 is accelerating a swinging movement of implement system 14, and segments of time during which swing motor 49 is decelerating the swinging movement of implement system 14. The acceleration segments may require significant energy from swing motor 49 that is conventionally realized by way of pressurized fluid supplied to swing motor 49 by pump 58, while the deceleration segments may produce significant energy in the form of pressurized fluid that is conventionally wasted through discharge to tank 60. Both the acceleration and the deceleration segments may require swing motor 49 to convert significant amounts of hydraulic energy to swing kinetic energy, and vice versa.

The pressurized fluid passing through swing motor 49 during deceleration, however, still contains a large amount of energy. If the fluid passing through swing motor 49 is selectively collected within first accumulator 108 during the deceleration segments, this energy can then be returned to (i.e., discharged) and reused by swing motor 49 during the ensuing acceleration segments. Swing motor 49 can be assisted during the acceleration segments by selectively causing first accumulator 108 to discharge pressurized fluid into the higher-pressure chamber of swing motor 49 (via conduit 116 and appropriate ones of the selector valves 120, 122, passages 112, 114, and chamber conduits 84, 86), alone or together with high-pressure fluid from pump 58, thereby propelling swing motor 49 at the same or greater rate with less pump power than otherwise possible via pump 58 alone. Swing motor 49 can be assisted during the deceleration segments by selectively causing first accumulator 108 to charge with fluid exiting swing motor 49, thereby providing additional resistance to the motion of swing motor 49 and lowering a restriction and cooling requirement of the fluid exiting swing motor 49.

The controller 100 may further be configured to selectively control charging of first accumulator 108 with fluid exiting pump 58. That is, during a peak-shaving or economy mode of operation, controller 100 may be configured to cause accumulator 108 to charge with fluid exiting pump 58 (e.g., via control valve 56, the appropriate ones of first and second chamber conduits 84, 86, passages 112, 114, selector valves 120, 122, and conduit 116) when pump 58 has excess capacity (i.e., a capacity greater than required by circuits 54, 56 to move work tool 16 as requested by the operator). Then, during times when pump 58 has insufficient capacity to adequately power swing motor 49, the high-pressure fluid previously collected from pump 58 within first accumulator 108 may be discharged in the manner described above to assist swing motor 49.

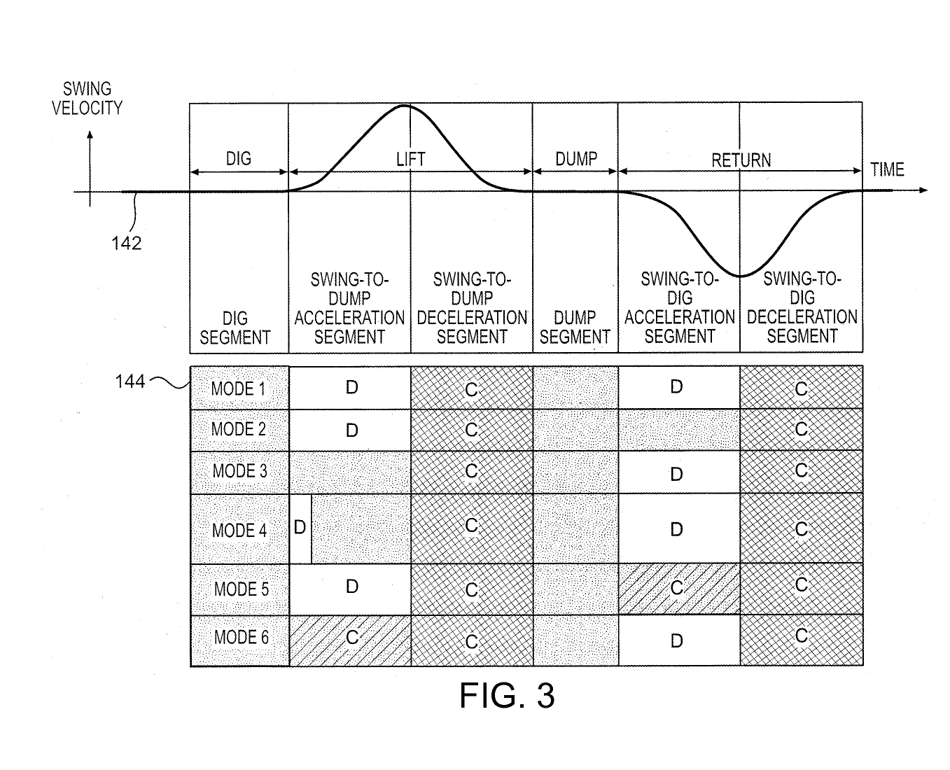

With reference to FIG. 3, an exemplary curve 142 may represent a swing speed signal generated by sensor(s) 141 relative to time throughout each segment of the excavation work cycle, for example throughout a work cycle associated with 90° truck loading. During most of the dig segment, the swing speed may typically be about zero (i.e., machine 10 may generally not swing during a digging operation). At completion of a dig stroke, machine 10 may generally be controlled to swing work tool 16 toward the waiting haul vehicle 12 (referring to FIG. 1). As such, the swing speed of machine 10 may begin to increase toward the end of the dig segment. As the swing-to-dump segment of the excavation work cycle progresses, the swing speed may accelerate to a maximum when work tool 16 is about midway between dig location 18 and dump location 20, and then decelerate toward the end of the swing-to-dump segment. During most of the dump segment, the swing speed may typically be about zero (i.e., machine 10 may generally not swing during a dumping operation). When dumping is complete, machine 10 may generally be controlled to swing work tool 16 back toward dig location 18 (referring to FIG. 1). As such, the swing speed of machine 10 may increase toward the end of the dump segment. As the swing-to-dig segment of the excavation cycle progresses, the swing speed may accelerate to a maximum in a direction opposite to the swing direction during the swing-to-dump segment of the excavation cycle. This maximum speed may generally be achieved when work tool 16 is about midway between dump location 20 and dig location 18. The swing speed of work tool 16 may then decelerate toward the end of the swing-to-dig segment, as work tool 16 nears dig location 18. Controller 100 may partition a current excavation work cycle into the six segments described above based on signals received from sensor(s) 141 and the maps and filters stored in memory, based on swing speeds, tilt forces, and/or operator input recorded for a previous excavation work cycle, or in any other manner known in the art.

Controller 100 may selectively cause first accumulator 108 to charge and to discharge based on the current or ongoing segment of the excavation work cycle. For example, a chart portion 144 (i.e., the lower portion) of FIG. 3 illustrates 6 different modes of operations during which the excavation cycle can be completed, together with an indication as to when first accumulator 108 is controlled to charge with pressurized fluid (represented by “C”) or to discharge pressurized fluid (represented by “D”) relative to the segments of each excavation work cycle. First accumulator 108 can be controlled to charge with pressurized fluid by moving one of valve elements 124, 126 of selector valves 120, 122 to the second or open position when the pressure within one of chamber conduits 84, 86 is greater than the pressure within first accumulator 108. First accumulator 108 can be controlled to discharge pressurized fluid by moving one of valve elements 124, 126 of selector valves 120, 122 to the second or flow-passing position when the pressure within first accumulator 108 is greater than the pressure within one of chamber conduits 84, 86.

Based on the chart of FIG. 3, some general observations may be made. First, it can be seen that controller 100 may inhibit first accumulator 108 from receiving or discharging fluid during the dig and dump segments of all of the modes of operation (i.e., controller 100 may maintain valve elements 124, 126 of selector valves 120, 122 in the flow-blocking closed positions during the dig and dump segments). Controller 100 may inhibit charging and discharging during the dig and dump segments, as no or little or no swinging motion is required during completion of these portions of the excavation work cycle. Second, the number of segments during which controller 100 causes first accumulator 108 to receive fluid may be greater than the number of segments during which controller 100 causes first accumulator 108 to discharge fluid for a majority of the modes (e.g., for modes 2-6). Controller 100 may generally cause first accumulator 108 to charge more often than discharge, because the amount of charge energy available at a sufficiently high pressure (i.e., at a pressure greater than the threshold pressure of first accumulator 108) may be less than an amount of energy required during movement of implement system 14. Third, the number of segments during which controller 100 causes first accumulator 108 to discharge fluid may never be greater than the number of segments during which controller 100 causes first accumulator 108 to receive fluid for all modes. Fourth, controller 100 may cause first accumulator 108 to discharge fluid during only a swing-to-dig or a swing-to-dump acceleration segment for all modes. Discharge during any other segment of the excavation cycle may only serve to reduce machine efficiency. Fifth, controller 100 may cause first accumulator 108 to receive fluid during only a swing-to-dig or swing-to-dump deceleration segment for a majority of the modes of operation (e.g., for modes 1-4).

Mode 1 may correspond with a swing-intensive operation where a significant amount of swing energy is available for storage by first accumulator 108. An exemplary swing-intensive operation may include a 150° (or greater) swing operation, such as the truck loading example shown in FIG. 1, material handling (e.g., using a grapple or magnet), hopper feeding from a nearby pile, or another operation where an operator of machine 10 typically requests harsh stop-and-go commands. When operating in mode 1, controller 100 may be configured to cause first accumulator 108 to discharge fluid to swing motor 49 during the swing-to-dump acceleration segment, receive fluid from swing motor 49 during the swing-to-dump deceleration segment, discharge fluid to swing motor 49 during the swing-to-dig acceleration segment, and receive fluid from swing motor 49 during the swing-to-dig deceleration segment.

Controller 100 may be instructed by the operator of machine 10 that the first mode of operation is currently in effect (e.g., that truck loading is being performed) or, alternatively, controller 100 may automatically recognize operation in the first mode based on performance of machine 10 monitored via sensor(s) 141. For example, controller 100 could monitor swing angle of implement system 14 between stopping positions (i.e., between dig and dump locations 18, 20) and, when the swing angle is repeatedly greater than a threshold angle, for instance greater than about 150°, controller 100 may determine that the first mode of operation is in effect. In another example, manipulation of input device 48 could be monitored via sensor(s) 141 to detect “harsh” inputs indicative of mode 1 operation. In particular, if the input is repeatedly moved from below a low threshold (e.g., about 10% lever command) to above a high threshold level (e.g., about 100% lever command) within a short period of time (e.g., about 0.2 sec or less), input device 48 may be considered to be manipulated in a harsh manner, and controller 100 may responsively determine that the first mode of operation is in effect. In a final example, controller 100 may determine that the first mode of operation is in effect based on a cycle and/or value of pressures within accumulator 108, for example when a threshold pressure is repetitively reached. In this final example, the threshold pressure may be about 75% of a maximum pressure.

Modes 2-4 may correspond generally with swing operations where only a limited amount of swing energy is available for storage by first accumulator 108. Exemplary swing operations having a limited amount of energy may include 90° truck loading, 45° trenching, tamping, or slow and smooth craning. During these operations, fluid energy may need to be accumulated from two or more segments of the excavation work cycle before significant discharge of the accumulated energy is possible. It should be noted that, although mode 4 is shown as allowing two segments of discharge from first accumulator 108, one segment (e.g., the swing-to-dump segment) may only allow for a partial discharge of accumulated energy. As with mode 1 described above, modes 2-4 may be triggered manually by an operator of machine 10 or, alternatively, automatically triggered based on performance of machine 10 as monitored via sensor(s) 141. For example, when machine 10 is determined to be repeatedly swinging through an angle less than about 100°, controller 100 may determine that one of modes 2-4 is in effect. In another example, controller 100 may determine that modes 2-4 are in effect based on operator requested boom movement less than a threshold amount (e.g., less than about 80% lever command for mode 2 or 4), and/or work tool tilting less than a threshold amount (e.g., less than about 80% lever command for mode 3 or 4).

During mode 2, controller 100 may cause first accumulator 108 to discharge fluid to swing motor 49 during only the swing-to-dump acceleration segment, receive fluid from swing motor 49 during the swing-to-dump deceleration segment, and receive fluid from swing motor 49 during the swing-to-dig deceleration segment. During mode 3, controller 100 may cause first accumulator 108 to receive fluid from swing motor 49 during the swing-to-dump deceleration segment, discharge fluid to swing motor 49 during only the swing-to-dig acceleration segment, and receive fluid from swing motor 49 during the swing-to-dig deceleration segment. During mode 4, controller 100 may cause first accumulator 108 to discharge only a portion of previously-recovered fluid to swing motor 49 during the swing-to-dump acceleration segment, receive fluid from swing motor 49 during the swing-to-dump deceleration segment, discharge fluid to swing motor 49 during the swing-to-dig acceleration segment, and receive fluid from swing motor 49 during the swing-to-dig deceleration segment.

Modes 5 and 6 may be known as economy or peak-shaving modes, where excess fluid energy during one segment of the excavation work cycle is generated by pump 58 (fluid energy in excess of an amount required to adequately drive swing motor 49 according to operator requests) and stored for use during another segment when less than adequate fluid energy may be available for a desired swinging operation. During these modes of operation, controller 100 may cause first accumulator 108 to charge with pressurized fluid from pump 58 during a swing acceleration segment, for example during the swing-to-dump or swing-to-dig acceleration segments, when the excess fluid energy is available. Controller 100 may then cause first accumulator 108 to discharge the accumulated fluid during another acceleration segment when less than adequate energy is available. Specifically, during mode 5, controller 100 may cause first accumulator 108 to discharge fluid to swing motor 49 during only the swing-to-dump acceleration segment, receive fluid from swing motor 49 during the swing-to-dump deceleration segment, receive fluid from pump 58 during the swing-to-dig acceleration segment, and receive fluid from swing motor 49 during the swing-to-dig deceleration segment, for a total of three charging segments and one discharging segment. During mode 6, controller 100 may cause first accumulator 108 to receive fluid from pump 58 during the swing-to-dump acceleration segment, receive fluid from swing motor 49 during the swing-to-dump deceleration segment, discharge fluid to swing motor 49 during the swing-to-dig acceleration segment, and receive fluid from swing motor 49 during the swing-to-dig deceleration segment.

It should be noted that controller 100 may be limited during the charging and discharging of first accumulator 108 by fluid pressures within first chamber conduit 84, second chamber conduit 86, and first accumulator 108. That is, even though a particular segment in the work cycle of machine 10 during a particular mode of operation may call for charging or discharging of first accumulator 108, controller 100 may only be allowed to implement the action when the related pressures have corresponding values. For example, if sensors 130, 134 indicate that a pressure of fluid within first accumulator 108 is below a pressure of fluid within first chamber conduit 84, controller 100 may not be allowed to initiate discharge of first accumulator 108 into first chamber conduit 84. Similarly, if sensors 132, 134 indicate that a pressure of fluid within second chamber conduit 86 is less than a pressure of fluid within first accumulator 108, controller 100 may not be allowed to initiate charging of first accumulator 108 with fluid from second chamber conduit 86. Not only could the exemplary processes be impossible to implement at particular times when the related pressures are inappropriate, but an attempt to implement the processes could result in undesired machine performance.

During the discharging of pressurized fluid from first accumulator 108 to swing motor 49, the fluid exiting swing motor 49 may still have an elevated pressure that, if allowed to drain into tank 60, may be wasted. At this time, second accumulator 110 may be configured to charge with fluid exiting swing motor 49 any time that first accumulator 108 is discharging fluid to swing motor 49. In addition, during the charging of first accumulator 108, it may be possible for swing motor 49 to receive too little fluid from pump 58 and, unless otherwise accounted for, the insufficient supply of fluid from pump 58 to swing motor 49 under these conditions could cause swing motor 49 to cavitate. Accordingly, second accumulator 110 may be configured to discharge to swing motor 49 any time that first accumulator 108 is charging with fluid from swing motor 49.

As described above, second accumulator 110 may discharge fluid any time a pressure within low-pressure passage 78 falls below the pressure of fluid within second accumulator 110. Accordingly, the discharge of fluid from second accumulator 110 into first circuit 52 may not be directly regulated via controller 100. However, because second accumulator 110 may charge with fluid from first circuit 52 whenever the pressure within drain passage 88 exceeds the pressure of fluid within second accumulator 110, and because control valve 56 may affect the pressure within drain passage 88, controller 100 may have some control over the charging of second accumulator 110 with fluid from first circuit 52 via control valve 56.

In some situations, it may be possible for both first and second accumulators 108, 110 to simultaneously charge with pressurized fluid. These situations may correspond, for example, with operation in the peak-shaving modes (i.e., in modes 5 and 6.). In particular, it may be possible for second accumulator 110 to simultaneously charge with pressurized fluid when pump 58 is providing pressurized fluid to both swing motor 49 and to first accumulator 108 (e.g., during the swing-to-dig acceleration segment of mode 5 and/or during the swing-to-dump acceleration segment of mode 6). At these times, the fluid exiting pump 58 may be directed into first accumulator 108, while the fluid exiting swing motor 49 may be directed into second accumulator 110.

Second accumulator 110 may also be charged via second circuit 54, if desired. In particular, any time waste fluid from second circuit 54 (i.e., fluid draining from second circuit 54 to tank 60) has a pressure greater than the threshold pressure of second accumulator 110, the waste fluid may be collected within second accumulator 110. In a similar manner, pressurized fluid within second accumulator 110 may be selectively discharged into second circuit 54 when the pressure within second circuit 54 falls below the pressure of fluid collected within second accumulator 110.

During charging and discharging of first accumulator 108, care should be taken to facilitate smooth transitions between pump-assisted swinging and accumulator-assisted swinging of implement system 14.

### INDUSTRIAL APPLICABILITY

Embodiments of the disclosed hydraulic control system 50 may be applicable to any excavation machine that performs a substantially repetitive work cycle, which involves swinging movements of a work tool.

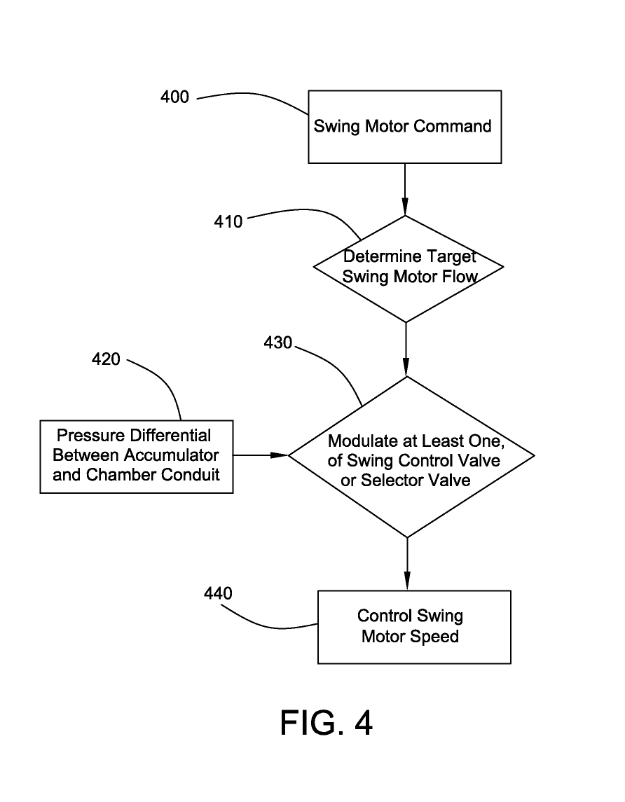

A graphic representation of a method associated with the hydraulic control system 50 is illustrated in FIG. 4. The controller 100 receives one or more commands regarding the operation of the swing motor 49 from, for example, one or more operator input devices 48 (Step 400). The controller 100 determines a target fluid flow through swing motor 49 to obtain the commanded operation (Step 410). The controller 100 further receives one or more signals indicative of the pressure differential between the first accumulator 108 and the appropriate first or second chamber conduit 84, 86 from which flow is required to obtain the target fluid flow through the swing motor 49 (Step 420). The controller 100 then modulates opening of the swing control valve 56 and at least one of the appropriate selector valve 120, 122 to regulate the flow of fluid from the pump 58 and the first accumulator 108 to obtain the target fluid flow through the swing motor 49 (Step 430) to control the swing motor speed (Step 440). Similarly, the operation of the swing control valve 56 and appropriate selector valve 120, 122 may be modulated to selectively recharge the first accumulator during deceleration or during periods of excess production by the pump 58.

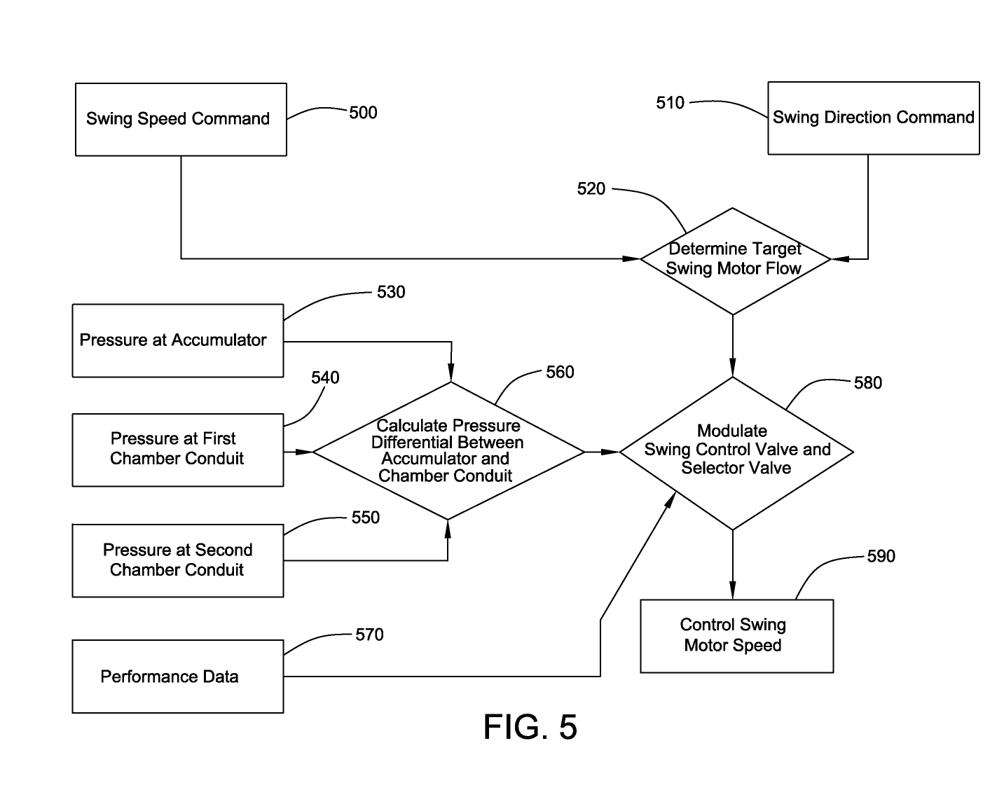

An alternate embodiment of a method associated with the hydraulic control system 50 is graphically illustrated in FIG. 5. As shown in FIG. 5, the swing motor command may be provided to the controller 100, for example, in the form of a swing speed command (Step 500) and/or a swing direction command (Step 510) from the operator. Based upon the swing speed command and/or the swing direction command, the controller 100 determines the target fluid flow through the swing motor 49 to obtain the commanded operation (Step 520). In this embodiment, the controller 100 receives signals reflecting information regarding the pressure differential between the appropriate first or second chamber conduit 84, 86 and the first accumulator 108 from the various pressure sensors 130, 132, 134 associated with the first or second chamber conduit 84, 86 and the first accumulator 108 (Steps 530, 540, and 550). From the signals indicative of pressure, the controller 100 may calculate a pressure differential between the first accumulator 108 and the appropriate chamber conduit 84, 86 (Step 560). Additional performance data may be provided to the controller 100 (Step 570). Based upon this pressure differential and the target fluid flow through the swing motor 49, the controller 100 then modulates the opening of the swing control valve 56 and the appropriate selector valve 120, 122 to regulate the flow of fluid from the pump 58 and the first accumulator 108 to obtain the target fluid flow through the swing motor 49 (Step 580), to control the swing motor speed (Step 590). As with the method represented in FIG. 4, the operation of the swing control valve 56 and appropriate selector valve 120, 122 may likewise be modulated to selectively recharge the first accumulator 108 during deceleration or during periods of excess production by the pump 58.

Further, the controller 100 may be configured to regulate the charging and discharging of first accumulator 108 based on a current or ongoing segment of the excavation, material handling, or other work cycle of machine 10. In particular, based on input received from one or more performance sensors 130, 132, 134, 141 (see FIG. 2), the controller 100 may be configured to partition a typical work cycle performed by machine 10 into a plurality of segments based upon signals indicative of such performance data (see FIG. 3). Such segments may include, for example, a dig segment, a swing-to-dump acceleration segment, a swing-to-dump deceleration segment, a dump segment, a swing-to-dig acceleration segment, and a swing-to-dig deceleration segment, as will be described in more detail below. Based on the segment of the excavation work cycle currently being performed, controller 100 may selectively cause first accumulator 108 to charge or discharge, thereby assisting swing motor 49 during the acceleration and deceleration segments.

One or more maps and/or dynamic elements relating signals from sensor(s) 130, 132, 134, 141 to the different segments of the excavation work cycle may be stored within the memory of controller 100. Each of these maps may include a collection of data in the form of tables, graphs, and/or equations. The dynamic elements may include integrators, filters, rate limiters, and delay elements. In one example, threshold speeds, cylinder pressures, and/or operator input (i.e., lever position) associated with the start and/or end of one or more of the segments may be stored within the maps. In another example, threshold forces and/or actuator positions associated with the start and/or end of one or more of the segments may be stored within the maps. Controller 100 may be configured to reference the signals from sensor(s) 130, 132, 134, 141 with the maps and filters stored in memory to determine the segment of the excavation work cycle currently being executed, and then regulate the charging and discharging of first accumulator 108 accordingly. Controller 100 may allow the operator of machine 10 to directly modify these maps and/or to select specific maps from available relationship maps stored in the memory of controller 100 to affect segment partitioning and accumulator control, as desired. It is contemplated that the maps may additionally or alternatively be automatically selectable based on modes of machine operation, if desired.

Sensor(s) 141 may be associated with the generally horizontal swinging motion of work tool 16 imparted by swing motor 49 (i.e., the motion of frame 42 relative to undercarriage member 44). For example, sensor 141 may embody a rotational position or speed sensor associated with the operation of swing motor 49, an angular position or speed sensor associated with the pivot connection between frame 42 and undercarriage member 44, a local or global coordinate position or speed sensor associated with any linkage member connecting work tool 16 to undercarriage member 44 or with work tool 16 itself, a displacement sensor associated with movement of operator input device 48, or any other type of sensor known in the art that may generate a signal indicative of a swing position, speed, force, or other swing-related parameter of machine 10. While the sensor 141 is illustrated in connection with the swing motor 49, it is to be understood that the sensor 141 may be alternately placed on the machine 10. The signal generated by sensor(s) 141 may be sent to and recorded by controller 100 during each excavation work cycle. It is contemplated that controller 100 may derive a swing speed based on a position signal from sensor 141 and an elapsed period of time, if desired.

Alternatively or additionally, sensor(s) 141 may be associated with the vertical pivoting motion of work tool 16 imparted by hydraulic cylinders 28 (i.e., associated with the lifting and lowering motions of boom 24 relative to frame 42). Specifically, sensor 141 may be an angular position or speed sensor associated with a pivot joint between boom 24 and frame 42, a displacement sensor associated with hydraulic cylinders 28, a local or global coordinate position or speed sensor associated with any linkage member connecting work tool 16 to frame 42 or with work tool 16 itself, a displacement sensor associated with movement of operator input device 48, or any other type of sensor known in the art that may generate a signal indicative of a pivoting position or speed of boom 24. It is contemplated that controller 100 may derive a pivot speed based on a position signal from sensor 141 and an elapsed period of time, if desired.

In yet an additional embodiment, sensor(s) 141 may be associated with the tilting force of work tool 16 imparted by hydraulic cylinder 38. Specifically, sensor 141 may be a pressure sensor associated with one or more chambers within hydraulic cylinder 38 or any other type of sensor known in the art that may generate a signal indicative of a tilting force of machine 10 generated during a dig and dump operation of work tool 16.

Some embodiments of the disclosed hydraulic control system 50 may help to improve machine performance and efficiency by assisting swinging acceleration and deceleration of the work tool with an accumulator during different segments of the work cycle.

The method used by the disclosed hydraulic control system 50 may provide smooth transition between pump-assisted activities and accumulator-assisted activities.

Some disclosed embodiments may provide compact packaging what may be appropriate for use in machines 10 including size limitations or smaller platforms.

Some embodiments may be economically included in machines 10 such as hydraulic excavators.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A control circuit comprising:
a swing motor, the swing motor having a first chamber and a second chamber, the swing motor moving in a first direction when fluid flows into the swing motor through the first chamber, the swing motor moving in a second direction when fluid flows into the swing motor through the second chamber;
first and second conduits, the first conduit connected to the first chamber of the swing motor, the second conduit connected to the second chamber of the swing motor;
a pump adapted to selectively provide fluid to the swing motor through the first and second conduits;
an accumulator;
at least one electrically-operated selector valve, the first selector valve being hydraulically connected to the first and second chambers and to the accumulator and being movable between a closed position wherein the accumulator is hydraulically blocked from the swing motor, a first open position wherein a flow path between the first chamber of the swing motor and the accumulator is defined, and a second open position wherein a flow path between the second chamber of the swing motor and the accumulator is defined;
at least one pressure sensor disposed to detect a pressure differential between the accumulator and at least one of the first chamber and the second chamber;
at least one swing control valve, the swing control valve hydraulically connected to the pump and to the first and second chamber conduits, the swing control valve movable between a first open position wherein a flow path between the pump and the first chamber conduit is defined, a second open position wherein a flow path between the pump and the second chamber conduit is defined, and at least one closed position wherein the pump and the swing motor are hydraulically blocked from each other; and
a controller in communication with the swing control valve and the selector valve, the controller being configured to:
receive input indicative of a pressure differential between the accumulator and at least one of the first chamber and the second chamber;
receive a swing motor command input;
calculate a target swing motor flow based on the swing motor command input; and
modulate operation of the swing control valve and the selector valve to regulate a swing speed.

2. The control circuit of claim 1 wherein the at least one selector valve includes at least electrically-operated first and second selector valves, the first selector valve being hydraulically connected to the first chamber conduit and to the accumulator and being movable between a closed position wherein the accumulator is hydraulically blocked from the first chamber of the swing motor and the first open position wherein a flow path between the first chamber of the swing motor and the accumulator is defined, the second selector valve being hydraulically connected to the second chamber conduit and to the accumulator and being movable between a closed position wherein the accumulator is hydraulically blocked from the second chamber of the swing motor and the second open position wherein a flow path between the second chamber of the swing motor and the accumulator is defined.

3. The control system of claim 2 further including a swing speed sensor associated with the swing motor, and wherein the at least one pressure sensor includes an accumulator pressure sensor operably arranged with the accumulator, a pressure sensor operably arranged with the first chamber conduit, and a pressure sensor operably arranged with the second chamber conduit, the controller being configured to receive input from the swing speed sensor and the pressure sensors.

4. The control system of claim 1 wherein the at least one selector valve is disposed hydraulically between the swing control valve and the first and second chambers of the swing motor.

5. The control system of claim 1 wherein the at least one pressure sensor includes an accumulator pressure sensor operably arranged with the accumulator, and at least one pressure sensor operably arranged with at least one of the first chamber conduit and the second chamber conduit.

6. The control system of claim 1 further including a swing speed sensor associated with the swing motor, the controller being configured to receive input from the swing speed sensor.

7. The control system of claim 1 further including a swing speed sensor associated with the swing motor, and wherein the at least one pressure sensor includes an accumulator pressure sensor operably arranged with the accumulator, a pressure sensor operably arranged with the first chamber conduit, and a pressure sensor operably arranged with the second chamber conduit, the controller being configured to receive input from the swing speed sensor and the pressure sensors.

8. A hydraulic control system, comprising:
a tank;
a pump configured to draw fluid from the tank and pressurize the fluid;
a swing motor driven by a flow of pressurized fluid, the swing motor having a first chamber and a second chamber, the swing motor moving in a first direction when fluid flows into the swing motor through the first chamber, the swing motor moving in a second direction when fluid flows into the swing motor through the second chamber;
at least one swing control valve configured to control fluid flow between the pump, the swing motor, and the tank;
an accumulator configured to selectively receive pressurized fluid discharged from the swing motor and selectively supply pressurized fluid to the swing motor;
at least one electrically-operated selector valve configured to regulate fluid flow into and out of the accumulator;
at least one pressure sensor disposed to detect a pressure differential between the accumulator and at least one of the first chamber and the second chamber; and
a controller in communication with the control valve and the selector valve, the controller being configured to:
receive input indicative of a pressure differential between the accumulator and at least one of the first chamber and the second chamber;
receive a swing motor command input;
calculate a target swing motor flow based on the swing motor command input; and
modulate operation of the swing control valve and the selector valve to regulate a swing speed.

9. The hydraulic control system of claim 8 wherein the input indicative of the pressure differential includes a first signal indicative of an accumulator pressure, and second signal indicative of pressure in at least one of the first and second chambers.

10. The hydraulic control system of claim 8 wherein the swing motor command input includes input from at least one of an operator directional command and an operator speed command.

11. The hydraulic control system of claim 8 wherein controller is further configured to receive input indicative of the speed of the swing motor.

12. The hydraulic control system of claim 8 further including a swing speed sensor associated with the swing motor, and wherein the at least one pressure sensor includes an accumulator pressure sensor operably arranged with the accumulator, a pressure sensor operably arranged with the first chamber, and a pressure sensor operably arranged with the second chamber, the controller being configured to receive input from the swing speed sensor and the pressure sensors.

13. The hydraulic control system of claim 8 wherein the at least one electrically-operated selector valve includes at least electrically-operated first and second selector valves, the first selector valve being hydraulically connected to the first chamber and to the accumulator and being movable between a closed position wherein the accumulator is hydraulically blocked from the first chamber of the swing motor and the first open position wherein a flow path between the first chamber of the swing motor and the accumulator is defined, the second selector valve being hydraulically connected to the second chamber and to the accumulator and being movable between a closed position wherein the accumulator is hydraulically blocked from the second chamber of the swing motor and the second open position wherein a flow path between the second chamber of the swing motor and the accumulator is defined.

14. A method of controlling a swing motor of a machine, comprising:
receiving input indicative of a pressure differential between an accumulator and at least one of a first chamber conduit and a second chamber conduit in communication with first and second chambers of a swing motor, respectively;
receiving a swing motor command input;
calculating a target swing motor flow based on the swing motor command input; and
modulating a swing control valve in communication with a pump and at least one selector valve in communication with the accumulator based upon the target swing motor flow and the pressure differential to regulate a swing speed of the swing motor.

15. The method of claim 14 wherein the swing motor command input includes indicative of a commanded speed and direction.

16. The method of claim 14 wherein the input indicative of a pressure differential includes input indicative of a pressure within the accumulator and input indicative of a pressure within at least one of the first and the second chamber conduit in communication with first and second chambers of the swing motor, respectively.

17. The method of claim 14 wherein the step of receiving input indicative of a pressure differential includes receiving input indicative of a pressure within the accumulator, receiving input indicative of a pressure within the first chamber conduit in communication with the first chamber of the swing motor, receiving input indicative of the pressure within the second chamber conduit in communication with the second chamber of the swing motor, and calculating the pressure differential between the accumulator and at least one of the first chamber conduit and the second chamber conduit in communication with first and second chambers of the swing motor, respectively.

18. The method of claim 14 wherein the modulating step includes modulating a position of the swing control valve and the selector valve to control flow to the first chamber to regulate the swing speed of the swing motor in a first direction, and modulating a position of the swing control valve and the selector valve to control flow to the second chamber to regulate the swing speed of the swing motor in a second direction.

19. The method of claim 18 wherein the at least one selector valve includes first and second selector valves, and the modulating step includes
closing the second selector valve and modulating positions of the swing control valve and the first selector valve to control flow to the first chamber to regulate the swing speed of the swing motor in the first direction, and
closing the first selector valve and modulating positions of the swing control valve and the selector valve to control flow to the second chamber to regulate the swing speed of the swing motor in the second direction.

20. The method of claim 19 wherein the swing motor command input includes indicative of a commanded speed and direction.
